(19) United States
(12) Patent Application Publication
(10) Pub. No.: US 2017/0010391 A1
(43) Pub. Date: Jan. 12, 2017

(54) HARD COATING FILM, POLARIZING PLATE AND IMAGE DISPLAY DEVICE INCLUDING THE SAME

(71) Applicant: DONGWOO FINE-CHEM CO., LTD., Jeollabuk-do (KR)

(72) Inventors: Geo San LIM, Seoul (KR); Dong Hwi KIM, Sejong (KR); Seung Hee KIM, Seoul (KR)

(21) Appl. No.: 15/201,775

(22) Filed: Jul. 5, 2016

(30) Foreign Application Priority Data
Jul. 10, 2015 (KR) 10-2015-0098429

(51) Int. Cl. G02B 1/14; G02B 5/30

(52) U.S. Cl. CPC G02B 1/14; G02B 5/3033

(57) ABSTRACT

A hard coating film satisfies the static frictional coefficient of 0.4 or less between an upper surface of a hard coating layer and a back surface of a substrate film, such that it is possible to achieve the hard coating film capable of suppressing a protrusion damage and having excellent anti-blocking properties while providing excellent transparency and hardness, as well as a polarizing plate including the hard coating film, and an image display device including the polarizing plate.

### CROSS-REFERENCE TO RELATED APPLICATION

The present application claims priority to Korean Patent Application No. 10-2015-0098429, filed on Jul. 10, 2015, the disclosure of which is incorporated herein by reference in its entirety.

### BACKGROUND

1. Technical Field

The present invention relates to a hard coating film, a polarizing plate and an image display device including the same, and more particularly, to a hard coating film in which an occurrence of protrusion and blocking is suppressed when winding the film, a polarizing plate including the hard coating film, and an image display device including the polarizing plate.

2. Description of the Related Art

A polarizing plate used in various image display devices such as a liquid crystal display (LCD), an organic electroluminescent (EL) display, a plasma display panel (PDP), a field emission display (FED), and an OLED generally includes a polarizer in which an iodine-based compound or a dichroic polarizing material is adsorbed and oriented in a polyvinyl alcohol (PVA) film. The polarizer has a multi-layered structure in which polarizer protective films are sequentially laminated on one surface thereof, and a polarizer protective film, an adhesive layer adhered to a liquid crystal, and a release film are sequentially laminated on the other surface thereof.

In the polarizing plate having the above-described structure, a hard coating film may be used as the polarizer protective film. In a case of a conventional hard coating film, when increasing a thickness thereof in order to improve a hardness, the obtained hardness of the hard coating film is increased, but a delamination occurs in a hard coating layer, and curling, that is, wrapping an end portion of the hard coating film due to curing shrinkage or thermal and moisture shrinkage is increased, hence resulting in poor workability.

In addition, there are problems that, during manufacturing the film, or during manufacturing a film roll by winding the same in a roll shape for storing or transporting the manufactured film, blocking in which a plastic substrate film and the hard coating layer are adhered to each other occurs, concave portions are formed in the product, or protrusions are generated on the film roll.

Korean Patent Laid-Open Publication No. 2014-0090291 discloses a method of manufacturing a hard-coated polarizer, however, did not suggest an alternative idea to solve the above-described problems.

### SUMMARY

Accordingly, it is an object of the present invention to provide a hard coating film which decreases a protrusion damage and suppresses an adhesion of the hard coating film without decreasing optical characteristics when winding the film, as well as has excellent anti-blocking properties.

In addition, another object of the present invention is to provide a hard coating film capable of achieving a high hardness.

Further, another object of the present invention is to provide a polarizing plate including the hard coating film, and an image display device including the polarizing plate.

The above objects of the present invention will be achieved by the following characteristics:

(1) A hard coating film including a hard coating layer formed on one surface of a substrate film, wherein a static frictional coefficient between an upper surface of the hard coating layer and a back surface of the substrate film is 0.4 or less.

(2) The hard coating film according to the above (1), wherein the static frictional coefficient is 0.1 to 0.4.

(3) The hard coating film according to the above (1), wherein the hard coating layer is formed by applying a composition for forming a hard coating layer to the one surface of the substrate film including at least a portion of a knurling part formed on at least one side thereof, and curing the same.

(4) The hard coating film according to the above (3), wherein the knurling part includes concavo-convexes formed on at least one side of the substrate film in a width direction thereof.

(5) The hard coating film according to the above (4), wherein the concavo-convex of the knurling part has a height of 0.5 to 3 μm.

(6) The hard coating film according to the above (3), wherein the one end portion of the hard coating layer has a height higher than the height of the other portion by 0.5 to 3 μm.

(7) The hard coating film according to the above (1), wherein the hard coating layer has a thickness of 1 to 20 μm.

(8) The hard coating film according to the above (1), wherein the hard coating layer is made of a composition for forming a hard coating layer including a photo-polymerizable compound, a photo-polymerization initiator, and a slipping additive.

(9) The hard coating film according to the above (8), wherein the photo-polymerizable compound includes at least one selected from a group consisting of at least one photo-polymerizable monomer selected from a group consisting of an ether of (meth)acrylic acid with polyalcohol, 1,4-cyclohexane diacrylate, 1,4-butandiol diacrylate, 1,6-hexanediol diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, and pentaerythritol hexa(meta); and

at least one photo-polymerizable oligomer selected from a group consisting of polyester (meth)acrylate, epoxy(meth)acrylate and polyether(meth)acrylate.

(10) The hard coating film according to the above (8), wherein the photo-polymerization initiator includes at least one initiator selected from a group consisting of acetophenones, benzoins, acyl phosphinoxides, titanocenes, benzophenones and thioxanthones.

(11) The hard coating film according to the above (8), wherein the composition for forming a hard coating layer further includes at least one solvent selected from a group consisting of an alcohol solvent, ketone solvent, ether solvent, acetate solvent, and hydrocarbon solvent.

(12) The hard coating film according to the above (1), wherein the substrate film includes at least one selected from a group consisting of triacetyl cellulose, acetyl cellulose butyrate, ethylene-vinyl acetate copolymer, propionyl cellulose, butyryl cellulose, acetylpropionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinylalcohol, polyvinylacetal, polyetherketone, polyetheretherketone, polyethersulfone, polymethyl methacrylate, polyethylene terephthalate, polybutylene terephthalate, polyethylene naphthalate and polycarbonate.

(13) A polarizing plate including: a polarizer; and the hard coating film according to any one of the above (1) to (12) adhered on at least one surface of the polarizer.

(14) A image display device including the polarizing plate according to the above (13).

The hard coating film of the present invention satisfies the static frictional coefficient of 0.4 or less between the upper surface of the hard coating layer and the back surface of the substrate film, such that it is possible to achieve the hard coating film capable of suppressing a protrusion damage and having excellent anti-blocking properties while providing excellent transparency and hardness.

In addition, the hard coating film of the present invention may be suitably applied to an image display device with a large size including the hard coating film and the polarizing plate.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a cross-sectional view schematically illustrating a hard coating film according to an embodiment of the present invention.

### DETAILED DESCRIPTION

The present invention discloses a hard coating film which satisfies the static frictional coefficient of 0.4 or less between an upper surface of a hard coating layer and a back surface of a substrate film, such that it is possible to achieve the hard coating film capable of suppressing a protrusion damage and having excellent anti-blocking properties while providing excellent transparency and hardness, as well as a polarizing plate including the hard coating film, and an image display device including the polarizing plate.

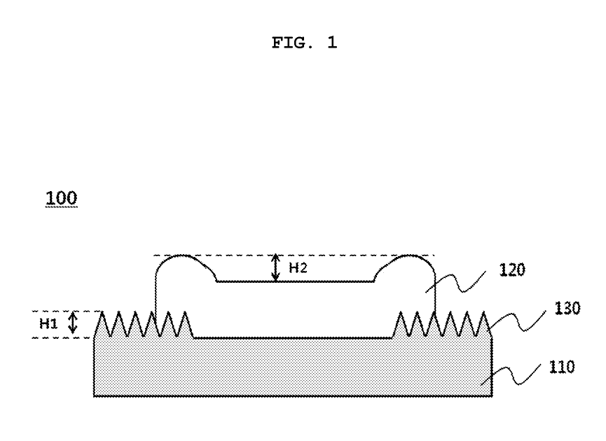

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

<Hard Coating Film>As illustrated in FIG. 1, a hard coating film 100 according to an embodiment of the present invention includes a hard coating layer 120 formed on one surface of a substrate film 110.

The hard coating film 100 of the present invention satisfies a static frictional coefficient of 0.4 or less between an upper surface of the hard coating layer 120 and a back surface of the substrate film 110.

The hard coating film including the hard coating layer is wound in a roll shape during manufacturing or for storing/transporting the manufactured film. When winding the hard coating film, there are problems that blocking in which an upper side and a lower side of the films are adhered to each other occurs, concave portions are formed in the product, or protrusions are generated on the film roll.

Thereby, the present inventor has conceived an idea that, when the static frictional coefficient between the upper surface of the hard coating layer and the back surface of the substrate film is 0.4 or less, it is possible to achieve the hard coating film capable of suppressing a protrusion damage and having excellent anti-blocking properties while providing excellent transparency and hardness, and based on the idea, has deduced the static frictional coefficient between the upper surface of the hard coating layer and the back surface of the substrate film and completed the present invention.

As described above, the hard coating film of the present invention satisfies the static frictional coefficient of 0.4 or less between the upper surface of the hard coating layer according to the embodiment of the present invention and the back surface of the substrate film, such that it is possible to simultaneously improve the transparency and hardness. In particular, by significantly suppressing an occurrence of the protrusion damage and blocking when winding the film, the hard coating film may be suitably applied to an image display device with a large size. Herein, since it is more preferable to have a lower static frictional coefficient, the lower limit thereof is not particularly limited, but in an aspect of further suppressing an occurrence of the protrusion damage and blocking, it is preferable that the static frictional coefficient is 0.1 to 0.4. If the static frictional coefficient between the upper surface of the hard coating layer and the back surface of the substrate film exceeds 0.4, there may be a problem that blocking between films occurs when winding due to a high friction therebetween.

In regard of the static frictional coefficient according to the present invention, for example, by adjusting types of a polymerizable compound of a composition for forming a hard coating layer, the number and/or a content of functional groups, and a content ratio of a polymerizable monomer and a polymerizable oligomer, as well as by using an additive or controlling a thickness of the hard coating layer, it is possible to satisfy the static frictional coefficient according to the present invention.

As illustrated in FIG. 1, the hard coating layer 120 according to the embodiment of the present invention may be formed by applying a composition for forming a hard coating layer to the one surface of the substrate film 100 including at least a portion of a knurling part 130 formed on at least one side thereof, and curing the same.

The knurling part 130 according to the present invention may include concavo-convexes formed on at least one side of the substrate film in a width direction thereof. A height H1 of the concavo-convex of the knurling part 130 is not particularly limited, but for example, may be 0.5 to 3 μm, and preferably, 1 to 2 μm. If the height of the concavo-convex is less than 0.5 μm, effects of preventing an occurrence of blocking may be insignificant. If the content thereof exceeds 3 μm, ensuring a uniform film is impossible leading to a poor appearance thereof.

As such, since the knurling part 130 is formed on at least one side of the substrate film 110 including the concavo-convexes in the width direction thereof, it is possible to form the hard coating layer having a height difference H2 between one end portion of the upper surface of the hard coating layer 120 and the other portion.

According to the embodiment of the present invention, the hard coating layer 120 formed on the substrate film 110 including the knurling part 130 may be configured in such a way that one end portion of the upper surface thereof has a height higher than the height of the other portion by 0.5 to 3 μs such, when the one end portion of the upper portion of the hard coating layer has a height higher than the height of the other portion by a predetermined length, it is possible to more increase effects of suppressing an occurrence of blocking and protrusion when winding the hard coating film. In consideration of these aspects, the height difference H2 may be 1 to 2 μm, for example. If the height difference is less than 1 μm, effects of preventing an occurrence of blocking may be insignificant. If the content thereof exceeds 2 μm, a step difference is excessively increased when winding the film at a length of 3000 m or more, and thereby the film may be bent or deformed.

The thickness of the hard coating layer 120 according to the present invention means a thickness except for a portion whose height is increased due to the knurling part 130 of the substrate film 110. More particularly, the thickness of the hard coating layer 120 means an average value from a surface of the substrate film to a surface of the hard coating layer at a central portion of the hard coating layer so as not to include the height of the one end portion which is an upper region of the knurling part 130 on an upper surface of the hard coating layer, and is not particularly limited, but may be 1 to 20 μm, and preferably, 3 to 10 μm, for example.

If the thickness of the hard coating layer exceeds 20 μm, is difficult to ensure transparency of a coating film, and ensuring a uniform film is impossible leading to a poor appearance thereof, while if it is less than 1 μm, curing of the coating film is deteriorated, thereby causing a difficulty in ensuring preferable mechanical characteristics. The thickness of the hard coating layer may be appropriately controlled so as to be suitable for a viscosity of a coating solution and an apparatus (for example, a coater) used in a coating process.

The hard coating layer is formed by applying the composition for forming a hard coating layer on the substrate film and curing the same, and may use any method known in the related art such as slit coating, knife coating, spin coating, casting, micro gravure coating, gravure coating, bar coating, roll coating, wire-bar coating, dip coating, spray coating, screen printing, gravure printing, flexo printing, offset printing, ink-jet coating, dispenser printing, nozzle coating, capillary coating, or the like.

<Composition for Forming a Hard Coating Layer>

hard coating layer according to the present invention may be made of a composition for forming a hard coating layer including a photo-polymerizable compound, a photo-polymerization initiator, and an additive such as a slipping additive.

Photo-Polymerizable Compound

photo-polymerizable compound used for forming the hard coating layer of the present invention includes a photo-polymerizable functional group, and may be a photo-polymerizable monomer, photo-polymerizable oligomer, or the like, and may be a photo-radical polymerizable compound, for example.

The photo-polymerizable monomer may use, for example, a monomer including an unsaturated group in a molecule such as a (meth)acryloyl, vinyl, styryl or allyl group as a photo-curable functional group generally used in the related art without particular limitation thereof, and more particularly, may include mono-functional and/or poly-functional (meth)acrylates, for example. These compounds may be used alone or in combination of two or more thereof.

In the present invention, “(meth)acryl-” refers to “methacryl-” or “acryl-,” or both of them.

A particular example of the (meth)acrylate monomer may include, as (meth)acrylic acid ester, trimethylolpropane tri(meth)acrylate, pentaerythritol tri(meth)acrylate, glycerol tri(meth)acrylate, tris(2-hydroxyethyl)isocyanurate tri(meth)acrylate, ethyleneglycol di(meth)acrylate, propyleneglycol (meth) acrylate, 1,3-butanediol di(meth)acrylate, 1,4-butanediol di(meth)acrylate, 1,6-hexanediol di(meth)acrylate, neopentylglycol di(meth)acrylate, diethyleneglycol di(meth)acrylate, triethyleneglycol di(meth)acrylate, dipropyleneglycol di(meth)acrylate, bis(2-hydroxyethyl)isocyanurate di(meth)acrylate, poly(meth)acrylate having ethylene oxide or propylene oxide added to the (meth) acrylic acid ester, etc.; oligo ester (meth)acrylate having 1 to 3 (meth)acryloyl groups in a molecule, oligo ether (meth)acrylic acid ester, oligo urethane (meth)acrylic acid and oligo epoxy (meth)acrylic acid, etc.; hydroxyethyl (meth) acrylate, hydroxypropyl (meth) acrylate, hydroxybutyl (meth)acrylate and products having ethylene oxide or propylene oxide added to the (meth) acrylic acid ester, etc.; mono(meth)acrylic acid ester, for example, a monomer having (meth)acryloyl groups of tri-functional or less such as isooctyl(meth)acrylate, isodecyl(meth)acrylate, stearyl(meth)acrylate, tetrahydrofurfuryl(meth)acrylate, phenoxyethyl(meth), etc.; and dipentaerythritol hexa(meth)acrylate, dipentaerythritol hydroxy penta(meth)acrylate, pentaerythritol tetra(meth)acrylate, ditrimethylolpropane tetra(meth)acrylate, or the like. These compounds may be used alone or in combination of two or more thereof.

The photo-polymerizable oligomer may use, for example, at least one selected from a group consisting of epoxy(meth)acrylate, urethane (meth)acrylate and polyester (meth)acrylate, and in particular, may use by mixing urethane (meth)acrylate and polyester (meth)acrylate, or may use by mixing two types of polyester (meth)acrylate. Preferably, in order to improve scratch resistance and hardness of a cured material, and increase an elastic modulus of the hard coating layer, urethane (meth)acrylate oligomer is used.

The urethane (meth)acrylate may be prepared by reacting poly-functional (meth)acrylate having a hydroxyl group in a molecule with a compound having an isocyanate group in the presence of a catalyst according to a method known in the related art.

A particular example of the poly-functional(meth)acrylate having a hydroxyl group in a molecule may include at least one selected from a group consisting of 2-hydroxylethyl (meth) acrylate, 2-hydroxylisopropyl (meth) acrylate, 4-hydroxybutyl (meth) acrylate, caprolactone ring-opened hydroxyacrylate, a pentaerythritol tri/tetra(meth)acrylate mixture, and a dipentaerythritol penta/hexa(meth)acrylate mixture.

A particular example of the compound having an isocyanate group may include at least one selected from a group consisting of 1,4-diisocyanatobutane, 1,6-diisocyanatohexane, 1,8-diisocyanantooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexenediisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethyl xylene-1,3-diisocyanate, 1-chloromethyl-2,4-diisocyanate, 4,4′-methylenebis(2,6-dimethylphenylisocyanate), 4,4′-oxybis(phenylisocyanate), tri-functional isocyanate derived from hexamethylenediisocynate, and trimethanepropanol adduct tolenediisocyanate.

More particularly, the urethane (meth)acrylate oligomer may include a compound which contains at least two substituents represented by Formula 1 below and at least two (meth)acryloyl groups:

—OC(═)NH— [Formula 1]

The urethane (meth)acrylate oligomer may include a compound obtained by reacting 1 mole of a diisocyanate represented by Formula 2 below with 2 moles of an active to hydrogen-containing polymerizable unsaturated compound.

R₁—OC(═O)NH—R₃—NHC(═O)O—R₂ [Formula 2]

(wherein R₁ and R₂ are each independently a substituent which contains a (meth)acryloyl group derived from an active hydrogen-containing polymerizable unsaturated compound, and R₃ is a divalent substituent derived from diisocyanate.

A particular example of the urethane (meth)acrylate oligomer may include products obtained by a reaction of 2-hydroxyethyl (meth)acrylate with 2,4-tolylene diisocyanate, reaction of 2-hydroxyethyl (meth)acrylate with isophorone diisocyanate, reaction of 2-hydroxybutyl (meth)acrylate with 2,4-tolylene diisocyanate, reaction of 2-hydroxybutyl (meth)acrylate with isophorone diisocyanate, reaction of pentaerythritol tri(meth)acrylate with 2,4-toluene diisocyanate, reaction of pentaerythritol tri(meth)acrylate with isophorone diisocyanate, reaction of pentaerythritol tri(meth) with dicyclohexylmethane diisocyanate, reaction of dipentaerythritol penta(meth)acrylate with isophorone diisocyanate, or reaction of dipentaerythritol penta(meth)acrylate with dicyclohexylmethane diisocyanate.

The polyester (meth)acrylate may be prepared by reacting polyester polyol with acrylic acid according to a method known in the related art.

The polyester (meth)acrylate may include at least one selected from a group consisting of polyester acrylate, polyester diacrylate, polyester tetraacrylate, polyester hexaacrylate, polyester pentaerythritol triacrylate, polyester pentaerythritol tetraacrylate, and polyester pentaerythritol hexaacrylate, but it is not limited thereto.

The photo-polymerizable monomer and the photo-polymerizable oligomer may be used alone or by mixing with each other. When the photo-polymerizable monomer and the photo-polymerizable oligomer are used by mixing with each other, workability and compatibility of the composition for forming a hard coating layer may be improved.

A content ratio of the photo-polymerizable monomer and the photo-polymerizable oligomer is not particularly limited, and may be appropriately selected in consideration of a storage modulus, contraction and workability of the hard coating layer. For example, they may be included in a content ratio of 10:1 to 1:10 of the photo-polymerizable oligomer to the photo-polymerizable monomer. If the content ratio of the photo-polymerizable oligomer to the photo-polymerizable monomer is beyond the above range, the storage modulus of the hard coating layer may be decreased or the contraction may be increased to reduce the hardness and flexibility, such that curling may occur.

A content of the photo-polymerizable compound is not particularly limited, but may be included, for example, in an amount of 1 to 80 parts by weight (“wt. parts”), and preferably, 5 to 50 wt. parts to 100 wt. parts of the composition for forming a hard coating layer. If the content of the photo-polymerizable compound is less than 1 wt. part, an elastic modulus of the coating layer is decreased, such that cracks may easily occur during bending. If the content thereof exceeds 80 wt. parts, a viscosity thereof may be increased to decrease applicability, and surface leveling may be insufficient to cause a problem entailed in appearance characteristics.

Photo-Polymerization Initiator

The photo-polymerization initiator used for forming the hard coating layer of the present invention is not particularly limited so long as it may form a radical by light irradiation.

For example, the photo-polymerization initiator may include a type I photo-initiator which generates the radical by degradation of a molecule due to a difference in a chemical structure or molecular binding energy, and a type II photo-initiator which generates the radical by hydrogen recapture. The typeI photo-initiator and the type II photo-initiator may be used alone or together with each other.

A particular example of the available type I photo-initiator may include acetophenones such as 4-phenoxy dichloro acetophenone, 4-t-butyl dichloro acetophenone, 4-t-butyl trichloro acetophenone, diethoxy acetophenone, 2-hydroxy-2-methyl-1-phenyl-1-one, 1-(4-isopropylphenyl)-2-hydroxy-2-methylpropane-1-one, 1-(4-dodecylphenyl)-2-hydroxy-2-methylpropane-1-one, 4-(2-hydroxyethoxy)-phenyl (2-hydroxy-2-propyl)ketone, 1-hydroxycyclohexyl phenylketone, etc.; benzoins such as benzoin, benzoin methylether, benzoin ethylether, benzyl dimethylketal, etc.; acylphosphine oxides; titanocene compounds, or the like. These compounds may be used alone or in combination of two or more thereof.

A particular example of the available type II photo-initiator may include benzophenones such as benzophenone, benzoylbenzoic acid, benzoylbenzoic acid methylether, 4-phenylbenzophenone, hydroxybenzophenone, 4-benzoyl-4′-methyldiphenyl sulfide, 3,3′-methyl-4-methoxybenzophenone, etc., or thioxanthones, 2-chlorothioxanthone, 2-methylthioxanthone, 2,4-dimethylthioxanthone, etc. These compounds may be used alone or in combination of two or more thereof.

A content of the photo-polymerization initiator is not particularly limited, but may be included, for example, in an amount of 0.1 to 10 wt. parts, and preferably, 1 to 5 wt. parts to 100 wt. parts of the composition for forming a hard coating layer. If the content of the photo-polymerization initiator is less than 0.1 wt. parts, curing cannot be sufficiently performed, thereby it is difficult to achieve mechanical properties or adhesion of the coating layer. If the content thereof exceeds 10 wt. parts, problems such as deterioration in adhesion, cracks, curling, or the like due to curing shrinkage may occur.

Additive

The additive used for forming the hard coating layer of the present invention plays a role of improving coating properties to the substrate film and decreasing a surface frictional coefficient. Among additives for improving surface coating properties generally and widely used, an additive having high slipping properties after curing is used. For instance, examples of the additive may include BYK-306, BYK-307, BYK-310, BYK-313, BYK-333, BYK-371, BYK-377, BYK-378, BYK-3440, BYK-UV3500, BYK-3550, BYK-UV3570, TEGO Glide 100, TEGO Glide 450, TEGO Glide B1484, TEGO Glide 420, TEGO Glide 482, TEGO Glide 410, TEGO Glide 415, or the like. These additives may be used alone or in combination of two or more thereof.

A content of the additive is not particularly limited, but may be included in an amount of 0.01 to 1 wt. part to 100 wt. parts of the composition for forming a hard coating layer, for example. If the content of the additive is less than 0.01 wt. parts, the additive cannot be sufficiently distributed on the surface of the substrate film, and thereby a decrease in the surface frictional coefficient may not be enough. If the content thereof exceeds 1 wt. part, compatibility with other compositions is decreased, such that precipitation may occur or economic advantages may be reduced.

In addition, the composition for forming a hard coating layer used for forming the hard coating layer according to the present invention may further include a leveling agent, UV stabilizer, thermal stabilizer, or the like other than the additive having high slipping properties.

The leveling agent is a component to endow smoothness and coating properties of the coating film.

The leveling agent may include a silicon leveling agent, fluorine leveling agent, acrylic polymer leveling agent, or the like. These agents may be used alone or in combination of two or more thereof.

A particular example of the commercially available leveling agent may include BYK-323, BYK-331, BYK-333, BYK-337, BYK-373, BYK-375, BYK-377 and BYK-378 manufactured by BYK Chemicals; TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300 and TEGO Rad 2500 manufactured by TEGO Co.; FC-4430 and FC-4432 manufactured by 3M Co., or the like.

The leveling agent may be included, for example, in an amount of 0.1 to 1 wt%. part to a total weight of the composition for forming a hard coating layer, but it is not limited thereto.

The UV stabilizer is a component to block or absorb UV rays, so as to prevent the cured hard coating layer from degrading, discoloring and crumbling due to an exposure to the UV rays.

The UV stabilizer may use UV ray absorbents, quenchers, hindered amine light stabilizers (HALSs), etc., according to an action mechanism, and phenyl salicylates (absorbents), benzophenone (absorbents), benzotriazole (quenchers), nickel derivatives (quenchers), radical scavengers, etc., according to a chemical structure. These compounds may be used alone or in combination of two or more thereof.

The thermal stabilizer may include, for example, polyphenol primary thermal stabilizers, phosphite secondary thermal stabilizers, lactone thermal stabilizers, or the like. These stabilizers may be used alone or in combination of two or more thereof.

Solvent

The solvent used for forming the hard coating layer of the present invention is not particularly limited so long as it may sufficient dissolve or disperse the composition. For example, the solvent may include an alcohol solvent (methanol, ethanol, isopropanol, butanol, propyleneglycol methoxy alcohol, etc.), ketone solvent (methylethylketone, methylbutylketone, methylisobutylketone, diethylketone, dipropylketone, etc.), ether solvent (diethyleneglycol dimethylether, diethyleneglycol diethylether, diethyleneglycol dipropylether, diethyleneglycol dibutylether, propyleneglycol monomethylether, etc.), acetate solvent (methyl acetate, ethyl acetate, butyl acetate, propyleneglycol methoxy acetate, etc.), cellosolve acetate (methyl cellosolve, ethyl cellosolve, propyl cellosolve, etc.), hydrocarbon solvent (normal hexane, normal heptane, benzene, toluene, xylene, etc.), or the like. These solvents may be used alone or in combination of two or more thereof.

A content of the solvent is not particularly limited, but may be included, for example, in an amount of 10 to 95 wt. parts, and preferably, 40 to 70 wt. parts to 100 wt. parts of the composition for forming a hard coating layer.

If the content of the solvent is less than 10 wt. parts, a viscosity of the composition is increased to cause a deterioration in workability, as well as, swelling of the substrate film cannot be sufficiently performed. If the content thereof exceeds 95 wt. parts, it requires extended time during drying, and thus economic advantages may be reduced.

The hard coating layer made of the above-described composition for forming a hard coating layer has excellent hardness and transparency, as well as, an occurrence of the protrusion and blocking when winding the film is suppressed.

The substrate film 110 may use any material regardless of types thereof so long as it is a polymer film, and may be a film made of polymers such as triacetyl cellulose, acetyl cellulose butyrate, ethylene-vinyl acetate copolymer, propionyl cellulose, butyryl cellulose, acetylpropionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinylalcohol, polyvinylacetal, polyetherketone, polyetheretherketone, polyethersulfone, polymethyl methacrylate, polyethylene terephthalate, polybutylene terephthalate, polyethylene naphthalate, polycarbonate, or the like. These polymers may be used alone or in combination of two or more thereof.

Among the substrate films, in a case of a polymer substrate film having a difficulty to endow adhesion after coating, when engineering plastic substrate or polymer substrate film whose surface is changed so as to have hydrophilic properties due to hydrolysis or saponification, it is difficult to increase the adhesion using a conventional composition for forming a hard coating layer, and as a result, mechanical properties may be decreased. However, the above-described composition for forming a hard coating layer of the present invention may achieve excellent adhesiveness with respect to these substrate films without decreasing the mechanical properties.

In order to improve the eadhesiveness, the substrate film may be subjected to a surface treatment such as a plasma treatment, corona treatment, or the like.

Polarizing Plate and Image Display Device

The present invention provides a polarizing plate formed by laminating the hard coating film on at least one surface of a polarizer.

The polarizing plate of the present invention is not particularly limited, however, may use various types of substances. For instance, examples of the above polarizing plate may include a mono-axially oriented film prepared by adsorbing a dichroic material such as iodine or dichroic dye to a hydrophilic polymer film such as a polyvinyl alcohol film and ethylene-vinyl acetate copolymer-based partially saponified film; a polyene oriented film such as a dehydrated material of polyvinyl alcohol or a dechlorinated material of polyvinyl chloride, or the like, but it is not limited thereto. Among these, a polarizing plate made of a polyvinyl alcohol film and dichroic material, i.e., iodine, is preferably used.

In addition, the present invention may provide an image display device having the hard coating film according to the present invention applied thereto by mounting the polarizing plate provided with the hard coating film inside the image display device. Further, the image display device of the present invention may further include components known in the related art other than the above component of the polarizing plate.

The image display device is not particularly limited, and the hard coating film of the present invention may be applicable to typical liquid crystal display devices, as well as an electro-luminescent display device, plasma display device, electro-luminescent emission display device, or the like. In particular, the hard coating film of the present invention is preferably applicable to a display having a large size due to suppressing an occurrence of protrusion and blocking when winding the film.

Hereinafter, preferred embodiments are proposed to more concretely describe the present invention. However, the following examples are only given for illustrating the present invention and those skilled in the art will obviously understand that various alterations and modifications are possible within the scope and spirit of the present invention. Such alterations and modifications are duly included in the appended claims.

### PREPARATIVE EXAMPLE 1

### Preparation of Composition for Forming a Hard Coating Layer

20 wt. parts of urethane acrylate having 10 functionalities (SC2153, Miwon Specialty Chemical Co.) and 20 wt. parts of pentaerythritol triacrylate (Miwon Specialty Chemical Co.) as a polymerizable compound, 2.8 wt. parts of Igacure 184 (1-hydroxy-cyclohexyl-phenyl-ketone, Ciba Co.) as a polymerization initiator, 37 wt. parts of methylethyl ketone and 20 wt. parts of propyleneglycol monomethyl ether as a solvent, and 0.2 wt. parts of BYK-333 (BYK-Chemie Co.) as a slipping additive were admixed. Then, the mixture was stirred with a stirrer and filtered using a filter made of a PP material to prepare a composition for forming a hard coating layer.

### PREPARATIVE EXAMPLES 2 to 8

Compositions for forming a hard coating layer were prepared according to the same procedures as described in

Preparative Example 1 except for using different compositions and contents (parts by weight) thereof listed in Table 1 below.

TABLE 1

| | Polymerizable | | Polymerization | | | | | |
|---|---|---|---|---|---|---|---|---|
| | compound | | initiator | | Solvent | | Additive | |
| Section | Composition | Content | Composition | Content | Composition | Content | Composition | Content |
| Preparative | A-1/A-2 | 20/20 | B-1 | 2.8 | C-1/C-2 | 37/20 | D-1 | 0.2 |
| Example 1 | | | | | | | | |
| Preparative | A-1/A-2 | 10/30 | B-1 | 2.8 | C-1/C-2 | 37/20 | D-2 | 0.2 |
| Example 2 | | | | | | | | |
| Preparative | A-1/A-2 | 20/20 | B-1 | 2.8 | C-1/C-2 | 37/20 | D-3 | 0.2 |
| Example 3 | | | | | | | | |
| Preparative | A-1/A-2 | 20/20 | B-1 | 2.8 | C-1/C-2 | 37/20 | D-4 | 0.2 |
| Example 4 | | | | | | | | |
| Preparative | A-1/A-2 | 20/20 | B-1 | 2.8 | C-1/C-2 | 37/20 | D-5 | 0.2 |
| Example 5 | | | | | | | | |
| Preparative | A-1/A-2 | 20/20 | B-1 | 2.995 | C-1/C-2 | 37/20 | D-1 | 0.005 |
| Example 6 | | | | | | | | |
| Preparative | A-1/A-2 | 40/42 | B-1 | 2.995 | C-1/C-2 | 10/5 | D-2 | 0.005 |
| Example 7 | | | | | | | | |
| Preparative | A-1/A-2 | 40/42 | B-1 | 2.91 | C-1/C-2 | 10/5 | D-2 | 0.09 |
| Example 8 | | | | | | | | |

A-1: urethane acrylate having 10 functionalities (SC2153, Miwon Specialty Chemical Co.)
A-2: pentaerythritol triacrylate (Miwon Specialty Chemical Co.)
B-1: Igacure 184 (1-hydroxy-cyclohexyl-phenyl-ketone, Ciba Co.)
C-1: methylethyl ketone
C-2: propyleneglycol monomethyl ether
D-1: slipping additive BYK-333 (BYK-Chemi Co.)
D-2: slipping additive BYK-378 (BYK-Chemi Co.)
D-3: slipping additive BYK-UV3500 (BYK-Chemi Co.)
D-4: slipping additive BYK- UV3570 (BYK-Chemi Co.)
D-5: leveling agent BYK- UV3530 (BYK-Chemi Co.)

### EXAMPLES AND COMPARATIVE EXAMPLES

In Examples 1 to 6 and comparative examples 1 to 4, hard coating layers were formed by applying the compositions for forming a hard coating layer having the compositions listed in Table 2 below to one surface of a triacetyl cellulose film having a thickness of 40 μm, on a knurling part with concavo-convexes formed thereon by spin coating with a film thicknesses (after drying) listed in Table 2, so as to cover the concavo-convexes on the knurling part by up to halves of a height thereof, then drying the solvent at 80° C. for 1 minute and curing the same by a high pressure mercury lamp at a light energy density of 200 mJ/cm² to prepare hard coating films.

Thereafter, the prepared hard coating films were wound with a length of 3900 m to prepare hard coating film rolls.

In this regard, in a case of Embodiment 6, a hard coating film was prepared according to the same procedures as described in Example 1 except that the composition for forming a hard coating layer of Preparative Example 1 was applied to a surface of a triacetyl cellulose film having a thickness of 40 μm on a portion in which the knurling part is not formed, instead of being applied to the knurling part with the concavo-convexes formed thereon of the triacetyl cellulose film.

TABLE 2

| | | Film thickness |
|---|---|---|
| Section | Composition | (μm) |
| Example 1 | Preparative | 5 |
| | Example 1 | |
| Example 2 | Preparative | 5 |
| | Example 2 | |
| Example 3 | Preparative | 5 |
| | Example 3 | |
| Example 4 | Preparative | 5 |
| | Example 4 | |
| Example 5 | Preparative | 10 |
| | Example 1 | |
| Example 6 | Preparative | 5 |
| | Example 1 | |
| Comparative Example 1 | Preparative | 5 |
| | Example 5 | |
| Comparative Example 2 | Preparative | 5 |
| | Example 6 | |
| Comparative Example 3 | Preparative | 5 |
| | Example 7 | |
| Comparative Example 4 | Preparative | 5 |
| | Example 8 | |

### EXPERIMENTAL EXAMPLE

The following evaluation for the hard coating films of the examples and comparative examples listed in Table 2 was performed.

(1) Measurement of Static Frictional Coefficient

Substrate films were cut in an A3 size and evenly fixed so as to place a substrate surface on a side opposite to the surface on which the hard coating layer is formed up, then the hard coating films of the examples and comparative examples were cut in an A4 size and adhered to a steel plate so that an upper surface of the hard coating layer comes in contact with the substrate surface, and then the steel plate adhered with the film was connected to a UTM. The steel plate was pulled by the UTM, and static frictional coefficients between two surfaces were measured. The measured results are shown in Table 3 below.

(2) Evaluation of Anti-Protruding Properties Wwhen Winding Hard Coating Film

During winding the hard coating films of the examples and comparative examples with a length of 3900 m, the number of protrusions which occurred on the wound rolls was visually observed and determined.

The anti-protruding properties were evaluated according to the following standards for evaluation, and the evaluated results are shown in Table 3 below.

<Standards for Evaluation>

⊚: 10 protusions or less occurred

◯: 11 to 20 protrusions occurred

Δ: 21 to 30 protrusions occurred

X: 31 protrusions or more occurred

(3) Evaluation of Anti-Blocking Properties

The hard coating films of the examples and comparative examples were wound with a length of 3900 m, and the wound rolls were left at 25° C. and 48 RH % for 4 weeks. Thereafter, the level of the blocking which occurred on the wound rolls was visually observed and determined.

The anti-blocking properties were evaluated according to the following standards for evaluation, and the evaluated results are shown in Table 3 below.

<Standards for Evaluation>

⊚: 10 protusions or less occurred

◯: 11 to 20 protrusions occurred

Δ: 21 to 30 protrusions occurred

X: 31 protrusions or more occurred

(4) Evaluation of Pencil Hardness

Using a pencil hardness tester (PHT, Korea Sukbo Science Co.), a pencil hardness of the hard coating films of the examples and comparative examples was measured by applying a load of 500 g thereto. A pencil, which is a product purchased from Mitsubishi Co., was used and the above test was repeatedly executed five (5) times per one pencil hardness test. The maximum pencil hardness in which at least three or less scratches were presented was determined as the pencil hardness of the corresponding hard coating layer. The evaluated results are shown in Table 3 below.

(5) Evaluation of Anti-Abrasive Properties

Using a steel wool tester (WT-LCM100, Korea Protech Co.), anti-abrasive properties of the hard coating films of the examples and comparative examples were measured by ten (10) times reciprocating a steel wool under a condition of 1 kg/(2cm×2cm). The steel wool of #0000 was used.

The anti-abrasive properties were evaluated according to the following standards for evaluation, and the evaluated results are shown in Table 3 below.

<Standards for Evaluation>

⊚: 10 protusions or less occurred

◯: 11 to 20 protrusions occurred

Δ: 21 to 30 protrusions occurred

X: 31 protrusions or more occurred

(6) Evaluation of Haze

Using a haze meter (HM-150, Murakami Co.), hazes of the hard coating films of the examples and comparative examples were measured. The measured results are shown in Table 3 below.

TABLE 3

| | | Anti- | | | | |
|---|---|---|---|---|---|---|
| | Static | protruding | | | | |
| | frictional | property | Anti- | Pencil | Anti- | |
| | coeffi- | when | blocking | hard- | abrasive | Haze |
| Section | cient | winding | property | ness | property | (%) |
| Example 1 | 0.15 | ⊚ | ⊚ | 3H | ⊚ | 0.2 |
| Example 2 | 0.21 | ⊚ | ⊚ | 3H | ⊚ | 0.2 |
| Example 3 | 0.34 | ⊚ | ⊚ | 3H | ⊚ | 0.3 |
| Example 4 | 0.37 | ⊚ | ⊚ | 4H | ⊚ | 0.2 |
| Example 5 | 0.17 | ◯ | ◯ | 4H | ⊚ | 0.2 |
| Example 6 | 0.16 | Δ | Δ | 3H | ⊚ | 0.3 |
| Compara- | 2.21 | X | X | 3H | ◯ | 0.2 |
| tive | | | | | | |
| Example 1 | | | | | | |
| Compara- | 0.84 | Δ | X | 3H | ◯ | 0.2 |
| tive | | | | | | |
| Example 2 | | | | | | |
| Compara- | 1.01 | X | X | 3H | ◯ | 0.2 |
| tive | | | | | | |
| Example 3 | | | | | | |
| Compara- | 0.5 | Δ | X | 3H | ⊚ | 0.3 |
| tive | | | | | | |
| Example 4 | | | | | | |

Referring to Table 3, in the case of the examples which satisfy the static frictional coefficient according to the present invention, it was confirmed that protrusion was prevented when winding the hard coating film and an occurrence of blocking was also suppressed, while exhibiting excellent pencil hardness, anti-abrasive properties and transparency.

In this regard, in the case of Example 6 that the hard coating layer is formed on the substrate film with no knurling part formed thereon, it was confirmed that some protrusions and blockings occurred when winding the film.

However, in the case of the comparative examples which do not satisfy the static frictional coefficient according to the present invention, it was confirmed that a significantly large number of protrusions and blockings occurred when winding the hard coating film, and anti-abrasive properties were decreased.

What is claimed is:

1. A hard coating film, comprising:
a substrate film;
a hard coating layer formed on one surface of the substrate film,
wherein a static frictional coefficient between an upper surface of the hard coating layer and a back surface of the substrate film is 0.4 or less.

2. The hard coating film according to claim 1, wherein the static frictional coefficient is 0.1 to 0.4.

3. The hard coating film according to claim 1, wherein the hard coating layer is formed by applying a composition for forming the hard coating layer to the one surface of the substrate film including at least a portion of a knurling part formed on at least one side thereof, and curing the same.

4. The hard coating film according to claim 3, wherein the knurling part includes concavo-convexes formed on at least one side of the substrate film in a width direction thereof.

5. The hard coating film according to claim 4, wherein the concavo-convex of the knurling part has a height of 0.5 to 3 μm.

6. The hard coating film according to claim 3, wherein the one end portion of the hard coating layer has a height higher than the height of the other portion by 0.5 to 3 μm.

7. The hard coating film according to claim 1, wherein the hard coating layer has a thickness of 1 to 20 μm.

8. The hard coating film according to claim 1, wherein the hard coating layer is made of a composition for forming a hard coating layer comprising a photo-polymerizable compound, a photo-polymerization initiator, and a slipping additive.

9. The hard coating film according to claim 8, wherein the photo-polymerizable compound includes at least one selected from a group consisting of at least one photo-polymerizable monomer selected from a group consisting of an ether of (meth)acrylic acid with polyalcohol, 1,4-cyclohexane diacrylate, 1,4-butandiol diacrylate, 1,6-hexanediol diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, and pentaerythritol hexa(meta); and
at least one photo-polymerizable oligomer selected from a group consisting of polyester (meth)acrylate, epoxy(meth)acrylate and polyether(meth)acrylate.

10. The hard coating film according to claim 8, wherein the photo-polymerization initiator includes at least one initiator selected from a group consisting of acetophenones, benzoins, acyl phosphinoxides, titanocenes, benzophenones and thioxanthones.

11. The hard coating film according to claim 8, wherein the composition for forming a hard coating layer further comprises at least one solvent selected from a group consisting of an alcohol solvent, ketone solvent, ether solvent, acetate solvent, and hydrocarbon solvent.

12. The hard coating film according to claim 1, wherein the substrate film includes at least one selected from a group consisting of triacetyl cellulose, acetyl cellulose butyrate, ethylene-vinyl acetate copolymer, propionyl cellulose, butyryl cellulose, acetylpropionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinylalcohol, polyvinylacetal, polyetherketone, polyetheretherketone, polyethersulfone, polymethyl methacrylate, polyethylene terephthalate, polybutylene terephthalate, polyethylene naphthalate and polycarbonate.

13. A polarizing plate comprising:
a polarizer; and
the hard coating film according to claim 1, the hard coating film adhered on at least one surface of the polarizer.

14. A image display device comprising the polarizing plate according to claim 13.
